(19) United States
(12) Patent Application Publication
(10) Pub. No.: US 2026/0121327 A1
(43) Pub. Date: Apr. 30, 2026

(54) MULTI-CONTACT TERMINAL STRUCTURE AND TERMINAL SHEET THEREOF

(71) Applicants: DINKLE ENTERPRISE CO., LTD., New Taipei City (TW); DINKLE ELECTRIC MACHINERY (CHINA) CO., LTD., Kunshan City (CN); LI YANG ELECTRIC MACHINERY (DONGGUAN) CO., LTD., Dong Guan City (CN)

(72) Inventor: Shang-Tsai WU, New Taipei City (TW)

(21) Appl. No.: 18/927,836

(22) Filed: Oct. 25, 2024

(51) Int. Cl. H01R 13/24; H01R 13/11; H01R 43/16

(52) U.S. Cl. CPC H01R 13/245; H01R 13/113; H01R 13/2457; H01R 13/2492; H01R 43/16

(57) ABSTRACT

The present disclosure provides a multi-contact terminal structure and a terminal sheet thereof. The multi-contact terminal structure includes a terminal main body formed by bending a terminal sheet. The terminal sheet includes continuous S-shaped through slots or comb-shaped through slots and a plurality of first terminal sections and second terminal sections divided by said slots and arranged alternatively to each other. The terminal main body includes first terminals formed by bending the first terminal sections and second terminals formed by bending the second terminal sections. The first terminals include first spacings formed thereamong, the second terminals include second spacings formed thereamong. The first terminals and the second spacings are arranged opposite from each other, and the second terminals and the first spacings are arranged opposite from each other.

### BACKGROUND OF THE DISCLOSURE

### Technical Field

The present disclosure relates to a terminal structure installed inside a terminal block or a connector, and in particular, to a multi-contact terminal structure and a terminal sheet thereof.

### Description of Related Art

Multi-contact terminals are widely applied to the internal of terminal blocks or connectors, and they are used to connect the bus bars of network energy equipment, unit basestation, server, internet network equipment or industrial power distribution equipment to circuit boards.

A known manufacturing method of multi-contact terminals use a processed sheet obtained with progressive dies, and chain terminals equipped with two rows of pins are formed at the middle to connect to the terminal respectively. However, due to the lack of overall planning, a lot of copper wastes and scraps are generated during the manufacturing process, resulting in the drawback of ineffective reduction of manufacturing cost.

In view of the above, the inventor seeks to overcome the aforementioned drawbacks associated with the current technology and aims to provide an effective solution through extensive researches along with utilization of academic principles and knowledge.

### SUMMARY OF THE INVENTION

The present disclosure provides a multi-contact terminal structure and a terminal sheet thereof, capable of utilizing a conductive metal sheet to form continuous S-shaped through slots or comb-shaped through slots, in order to divide a plurality of first terminal sections and a plurality of second terminal sections arranged alternatively to each other, thereby achieving the advantages of reduction of manufacturing cost for the multi-contact terminal structure and the terminal sheet thereof of the present disclosure.

In an exemplary embodiment of the present disclosure, the present disclosure provides a multi-contact terminal structure having: a terminal main body formed by bending a terminal sheet, the terminal sheet having a conductive metal sheet, the conductive metal sheet having at least one continuous S-shaped through slot or at least one comb-shaped through slot and a plurality of first terminal sections and a plurality of second terminal sections divided by the at least one continuous S-shaped through slot or the at least one comb-shaped through slot and arranged alternatively to each other, the terminal main body having a plurality of first terminals formed by bending the plurality of first terminal sections and a plurality of second terminals formed by bending the plurality of second terminal sections, the plurality of first terminals having a plurality of first spacings formed thereamong, the plurality of second terminals having a plurality of second spacings formed thereamong, the plurality of first terminals and the plurality of second spacings arranged opposite from each other, the plurality of second terminals and the plurality of first spacings arranged opposite from each other.

In an exemplary embodiment of the present disclosure, the present disclosure provides a terminal sheet having: a conductive metal sheet having at least one continuous S-shaped through slot or at least one comb-shaped through slot and a plurality of first terminal sections and a plurality of second terminal sections divided by the at least one continuous S-shaped through slot or the at least one comb-shaped through slot and arranged alternatively to each other.

In view of the above, as a conductive metal sheet is utilized to form continuous S-shaped through slots or comb-shaped through slots, they are able to divide and form a plurality of first terminal sections and a plurality of second terminal sections arranged alternatively to each other, such that it is not necessary to form excessive cutting slots other than the continuous S-shaped through slots or comb-shaped through slots via stamping of the conductive metal sheet, and generation of copper wastes and scraps during the manufacturing process may be reduced, thereby achieving the advantages of reduction of copper scraps and effectively reduction of manufacturing cost for the multi-contact terminal structure and the terminal sheet thereof of the present disclosure.

### BRIEF DESCRIPTION OF THE DRAWINGS

FIG. 1 is a perspective view of the first exemplary embodiment of the multi-contact terminal structure of the present disclosure;

FIG. 2 is a front view of the first exemplary embodiment of the multi-contact terminal structure of the present disclosure;

FIG. 3 is a cross sectional view of the first exemplary embodiment of the multi-contact terminal structure of the present disclosure;

FIG. 4 is a top view of the first exemplary embodiment of the terminal sheet of the present disclosure;

FIG. 5 shows a state of use of the first exemplary embodiment of the multi-contact terminal structure of the present disclosure;

FIG. 6 shows another state of use of the first exemplary embodiment of the multi-contact terminal structure of the present disclosure;

FIG. 7 is a perspective view of the second exemplary embodiment of the multi-contact terminal structure of the present disclosure;

FIG. 8 is a front view of the second exemplary embodiment of the multi-contact terminal structure of the present disclosure;

FIG. 9 is a cross sectional view of the second exemplary embodiment of the multi-contact terminal structure of the present disclosure;

FIG. 10 is a top view of the second exemplary embodiment of the terminal sheet of the present disclosure;

FIG. 11 shows a state of use of the second exemplary embodiment of the multi-contact terminal structure of the present disclosure;

FIG. 12 is a perspective view of the third exemplary embodiment of the multi-contact terminal structure of the present disclosure;

FIG. 13 is a front view of the third exemplary embodiment of the multi-contact terminal structure of the present disclosure;

FIG. 14 is a cross sectional view of the third exemplary embodiment of the multi-contact terminal structure of the present disclosure;

FIG. 15 is a top view of the third exemplary embodiment of the terminal sheet of the present disclosure;

FIG. 16 shows a state of use of the third exemplary embodiment of the multi-contact terminal structure of the present disclosure;

FIG. 17 is a perspective view of the fourth exemplary embodiment of the multi-contact terminal structure of the present disclosure;

FIG. 18 is a front view of the fourth exemplary embodiment of the multi-contact terminal structure of the present disclosure;

FIG. 19 is a cross sectional view of the fourth exemplary embodiment of the multi-contact terminal structure of the present disclosure;

FIG. 20 is a top view of the fourth exemplary embodiment of the terminal sheet of the present disclosure;

FIG. 21 shows a state of use of the fourth exemplary embodiment of the multi-contact terminal structure of the present disclosure;

FIG. 22 is a perspective view of the fifth exemplary embodiment of the multi-contact terminal structure of the present disclosure;

FIG. 23 is a front view of the fifth exemplary embodiment of the multi-contact terminal structure of the present disclosure;

FIG. 24 is a cross sectional view of the fifth exemplary embodiment of the multi-contact terminal structure of the present disclosure;

FIG. 25 is a top view of the fifth exemplary embodiment of the terminal sheet of the present disclosure; and

FIG. 26 shows a state of use of the fifth exemplary embodiment of the multi-contact terminal structure of the present disclosure.

### DETAILED DESCRIPTION

The technical contents of this disclosure will become apparent with the detailed description of embodiments and the accompanied drawings as follows. However, it shall be noted that the accompanied drawings for illustrative purposes only such that they shall not be used to restrict the scope of the present disclosure.

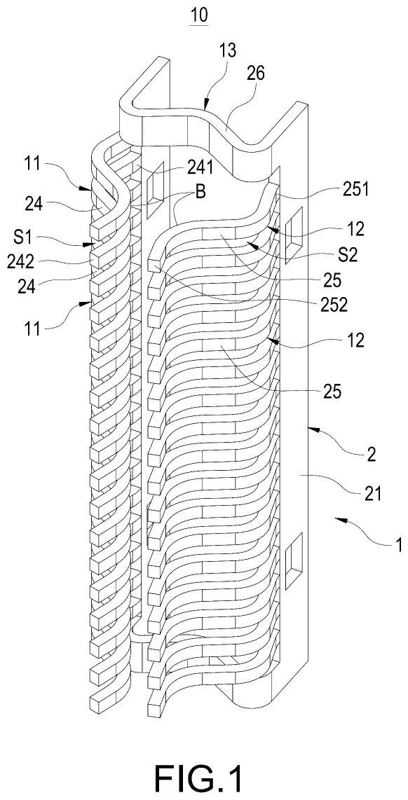

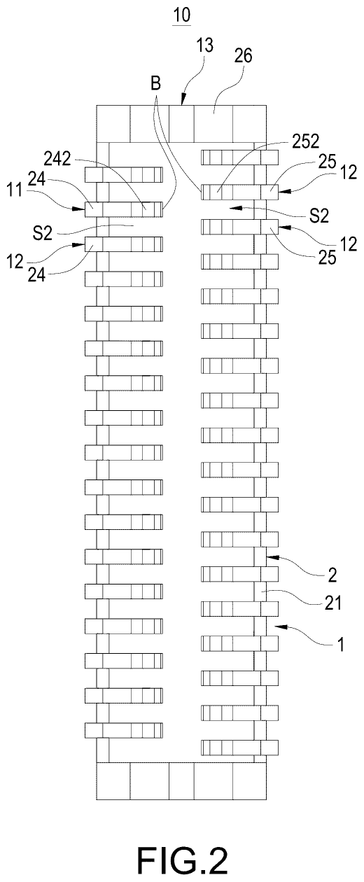

The present disclosure provides a multi-contact terminal structure and a terminal sheet thereof. Please refer to FIG. 1 to FIG. 6. According to a first exemplary embodiment of a multi-contact terminal structure 10 and a terminal sheet 2 of the present disclosure, the multi-contact terminal structure 10 mainly includes a terminal main body 1, and the terminal sheet 2 includes a conductive metal sheet 21.

As shown in FIG. 1 to FIG. 6, the terminal main body 1 is formed by bending a terminal sheet 2, and the terminal sheet 2 includes a conductive metal sheet 21. The conductive metal sheet 21 includes one or a plurality of continuous S-shaped through slots 22 and a plurality of first terminal sections 24 and a plurality of second terminal sections 25 divided by the continuous S-shaped through slots 22 and arranged alternatively to each other. In addition, a quantity of the continuous S-shaped through slots 22 in this exemplary embodiment is one; however, the present disclosure is not limited to such quantity only.

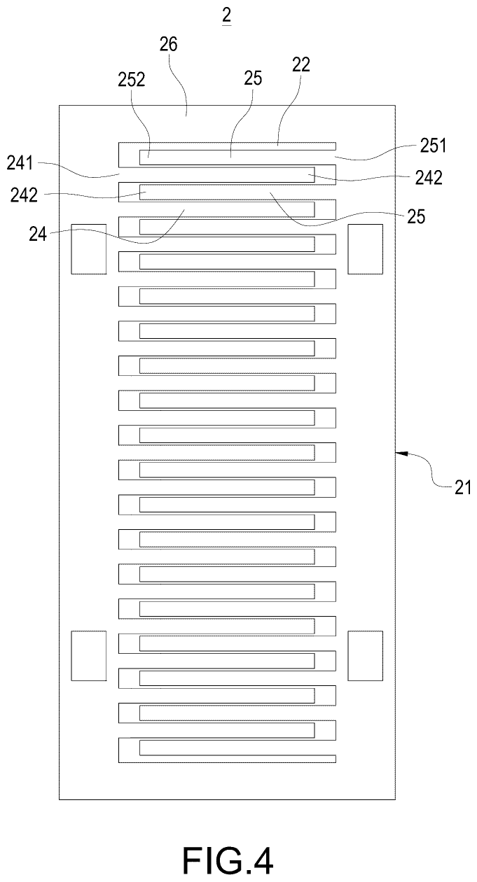

Please refer to further description below. As shown in FIG. 4, the conductive metal sheet 21 includes a frame section 26 formed at a peripheral of the at least one continuous S-shaped through slot 22. Each of the first terminal sections 24 includes a first connecting end 241 formed at one end thereof and connected to the frame section 26 and a first free end 242 formed at another end thereof and separated from the frame section 26. Each of the second terminal sections 25 includes a second connecting end 251 formed at one end thereof and connected to the frame section 26 and a second free end 252 formed at another end thereof and separated from the frame section 26. Each of the first free ends 242 and each of the second connecting ends 251 are arranged adjacent and parallel to each other, and each of the second free ends 252 and each of the first connecting ends 241 are arranged adjacent and parallel to each other.

Subsequently, the conductive metal sheet 21 then undergoes pressing and bending operations. As shown in FIG. 1 to FIG. 3, in this exemplary embodiment, the terminal main body 1 includes a W-shaped bracket 13 formed by bending the frame section 26, the terminal main body 1 includes a plurality of first terminals 11 formed by bending the plurality of first terminal sections 24 and a plurality of second terminals 12 formed by bending the plurality of second terminal sections 25, such that the plurality of first terminals 11 are arranged parallel to each other vertically and extended from one of a left side and a right side of the W-shaped bracket 13, and the plurality of second terminals 12 are arranged parallel to each other vertically and extended from another one of the left side and the right side of the W-shaped bracket 13.

Furthermore, the plurality of first terminals 11 includes a plurality of first spacings S1 formed thereamong, and the plurality of second terminals 12 includes a plurality of second spacings S2 formed thereamong. The plurality of first terminals 11 and the plurality of second spacings S2 are arranged spaced apart and opposite from each other, and the plurality of second terminals 12 and the plurality of first spacings S1 are arranged spaced apart and opposite from each other.

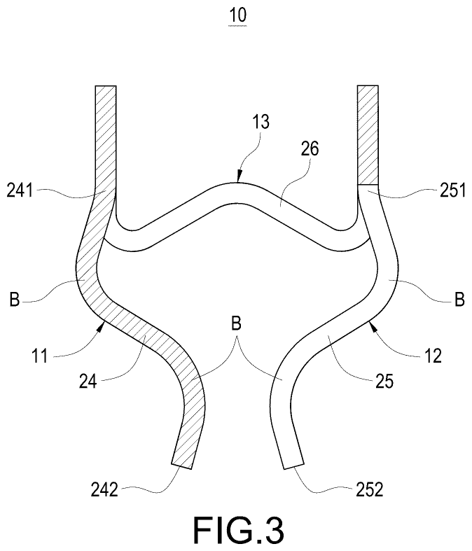

Moreover, as shown in FIG. 1 and FIG. 3, each of the first terminals 11 and each of the second terminals 12 include two bending points B respectively, thereby allowing each of the first terminals 11 and each of the second terminals 12 to approach each other toward the first free end 242 and the second free end 252 respectively first, and to further extend away from each other in a V shape.

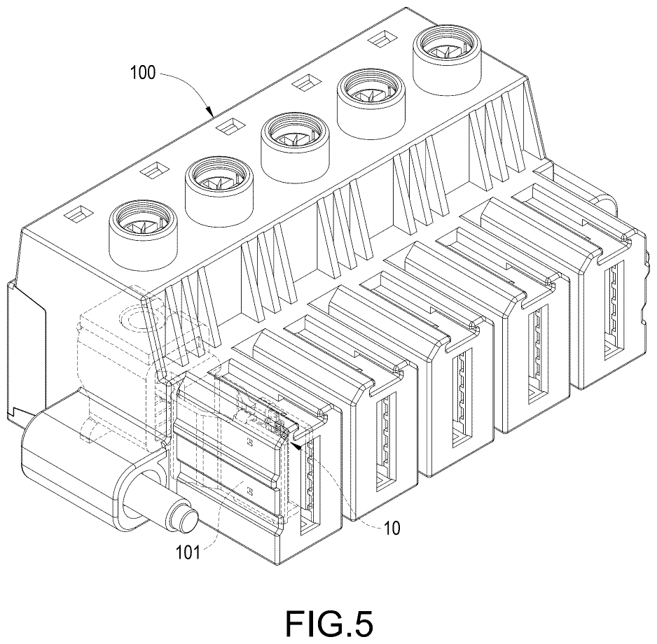

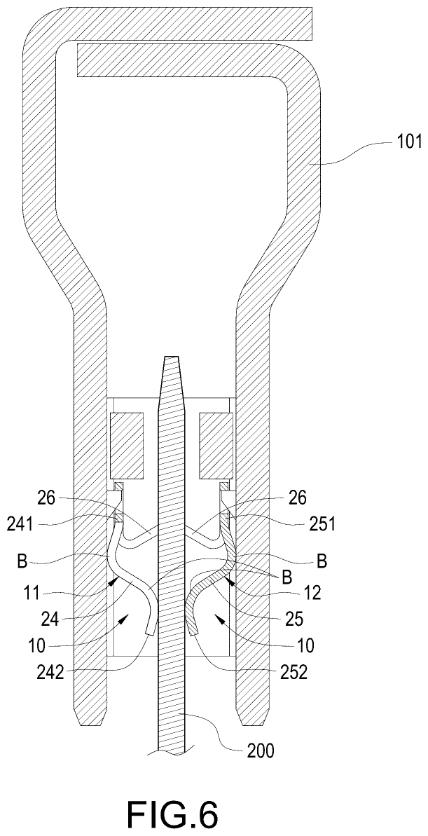

Please refer to FIG. 5 to FIG. 6, showing a state of use of the multi-contact terminal structure 10 of the present disclosure. The terminal main body 1 is installed at the inner side of the conducting slab 101 of the terminal block 100. When a male end terminal 200 is inserted into the terminal block 100, the male end terminal 200 is clamped by the plurality of first terminals 11 and the plurality of second terminals 12, and is also electrically connected to the conducting slab 101 via the terminal main body 1.

In addition, as shown in FIG. 1 to FIG. 4, the terminal main body 1 is formed by bending the conductive metal sheet 21. As the conductive metal sheet 21 includes the continuous S-shaped through slots 22 formed thereon, they are able to divide and form a plurality of first terminal sections 24 and a plurality of second terminal sections 25 arranged alternatively to each other. Accordingly, it is not necessary to form excessive cutting slots other than the continuous S-shaped through slots 22 via stamping of the conductive metal sheet 21, and generation of copper wastes and scraps during the manufacturing process may be reduced, thereby achieving the advantages of reduction of copper scraps and effectively reduction of manufacturing cost for the multi-contact terminal structure 10 and the terminal sheet 2 thereof of the present disclosure.

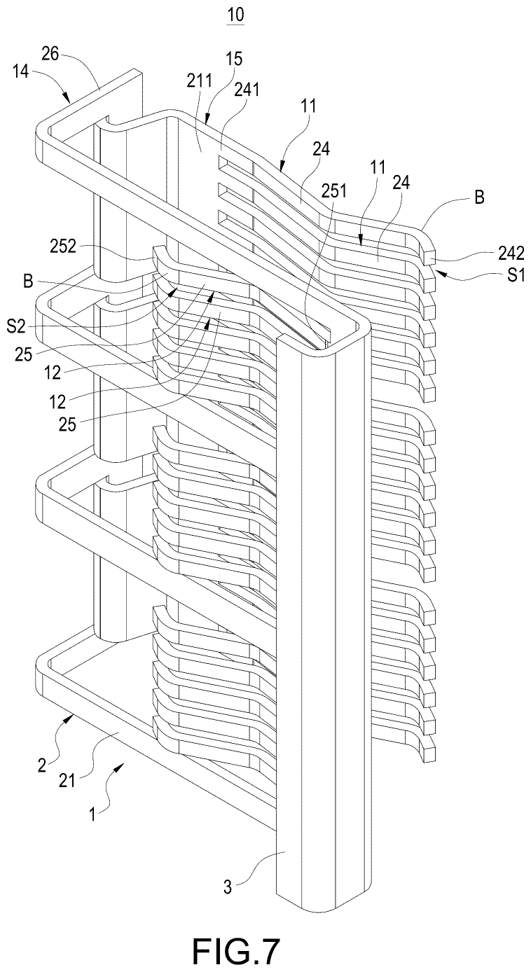

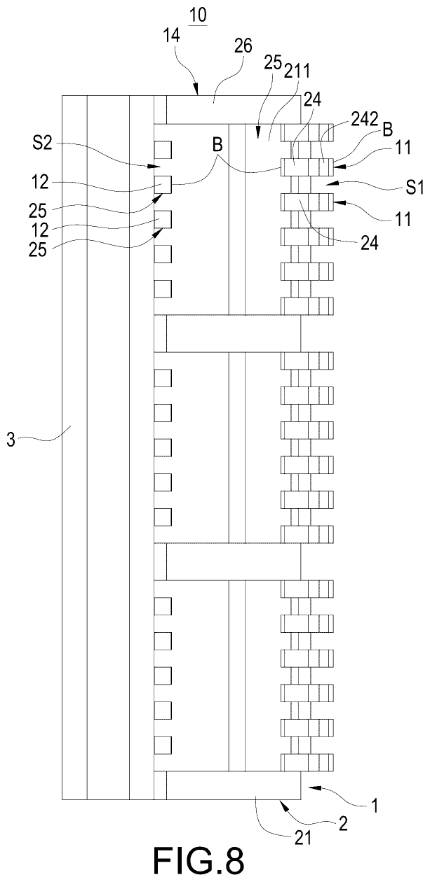

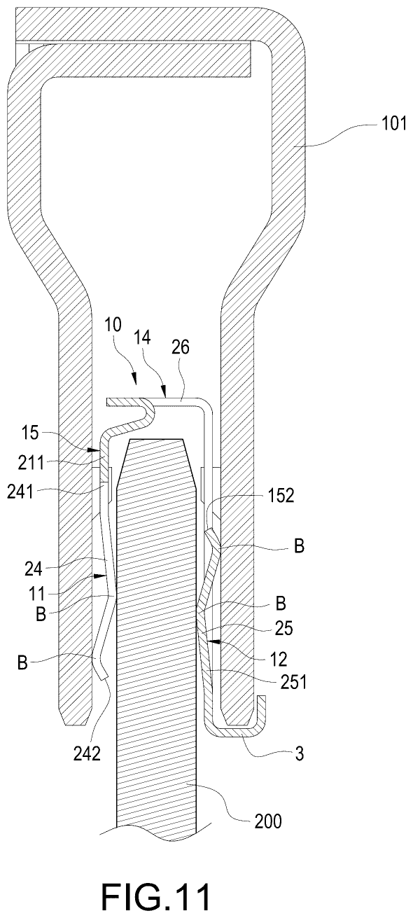

Please refer to FIG. 7 to FIG. 11, showing a second exemplary embodiment of a multi-contact terminal structure 10 and a terminal sheet 2 thereof of the present disclosure. The exemplary embodiment shown in FIG. 7 to FIG. 11 is generally identical to the exemplary embodiment shown in FIG. 1 to FIG. 6. The difference between the exemplary embodiment shown in FIG. 7 to FIG. 11 and the exemplary embodiment shown in FIG. 1 to FIG. 6 mainly relies in the different bending shape of the terminal main body 1.

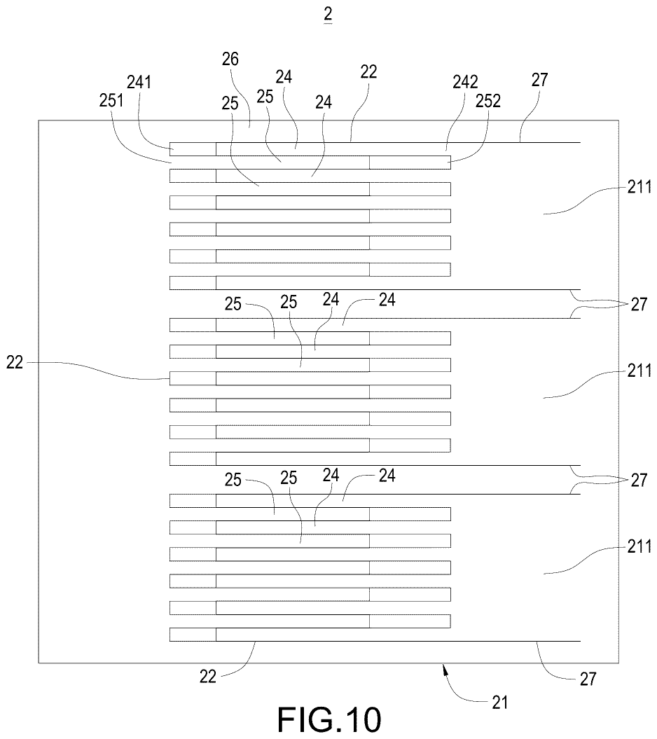

Please refer to further description below. As shown in FIG. 10, in this exemplary embodiment, a quantity of the continuous S-shaped through slots 22 is multiple; however, the present disclosure is not limited to such quantity only. The conductive metal sheet 21 further includes two elongated slots 27 extended from two rear ends of the continuous S-shaped through slots 22 and arranged opposite from each other vertically. The conductive metal sheet 21 includes an extension section 211 formed between the two elongated slots 27, and each of the first connecting ends 241 and the extension section 211 are integrally formed to be connected to each other.

Subsequently, the conductive metal sheet 21 then undergoes pressing and bending operations. As shown in FIG. 7 to FIG. 9, the terminal main body 1 includes an L-shaped bracket 14 formed by bending the frame section 26 and a vertical protruding slab 15 formed by bending the extension section 211 and arranged at one side of the L-shaped bracket 14. The plurality of first terminals 11 extend from a rear end of the vertical protruding slab 15 away from the L-shaped bracket 14, and the plurality of second terminals 12 extend from an inner edge of one end of the L-shaped bracket 14 away from the vertical protruding slab 15 and towards an internal of the L-shaped bracket 14. In other words, the plurality of first terminals 11 extend from the vertical protruding slab 15 and are arranged parallel to each other vertically, and the plurality of second terminals 12 extend from the L-shaped bracket 14 and are arranged parallel to each other vertically. In addition, each of the first terminals 11 and each of the second terminals 12 are formed to extend in opposite directions. The plurality of first terminals 11 and the plurality of second spacings S2 are arranged spaced apart and opposite from each other, and the plurality of second terminals 12 and the plurality of first spacings S1 are arranged spaced apart and opposite from each other.

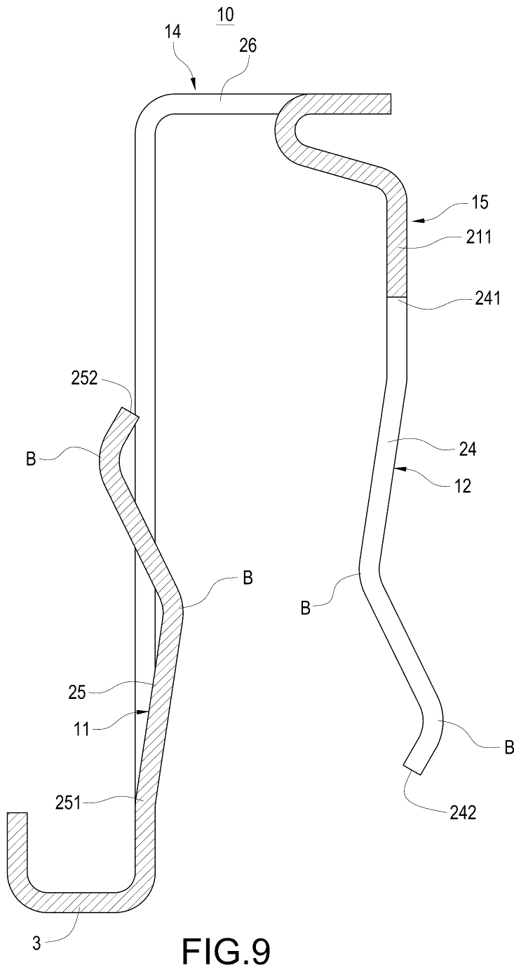

Furthermore, as shown in FIG. 7 and FIG. 9, each of the first terminals 11 and each of the second terminals 12 include two bending points B respectively, thereby allowing each of the first terminals 11 and each of the second terminals 12 to approach each other with a portion thereof and to extend further away from each other with another portion thereof. Moreover, the L-shaped bracket 14 includes an L-shaped hook 3 extended from one end away from the vertical protruding slab 15, such that it may be locked to one end of the conducting slab 101via the L-shaped hook 3.

Accordingly, in this exemplary embodiment, as the conductive metal sheet 21 includes the continuous S-shaped through slots 22 formed thereon, they are able to divide and form a plurality of first terminal sections 24 and a plurality of second terminal sections 25 arranged alternatively to each other. As a result, it is not necessary to form excessive cutting slots other than the continuous S-shaped through slots 22 via stamping of the conductive metal sheet 21, to achieve equivalent functions and effects of the exemplary embodiment illustrated in FIG. 1 to FIG. 6.

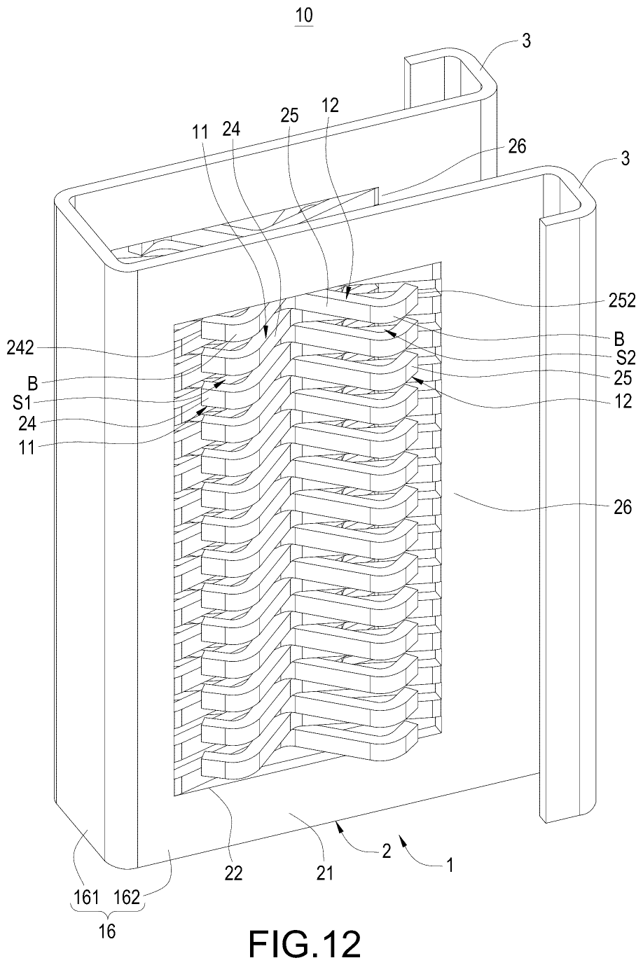

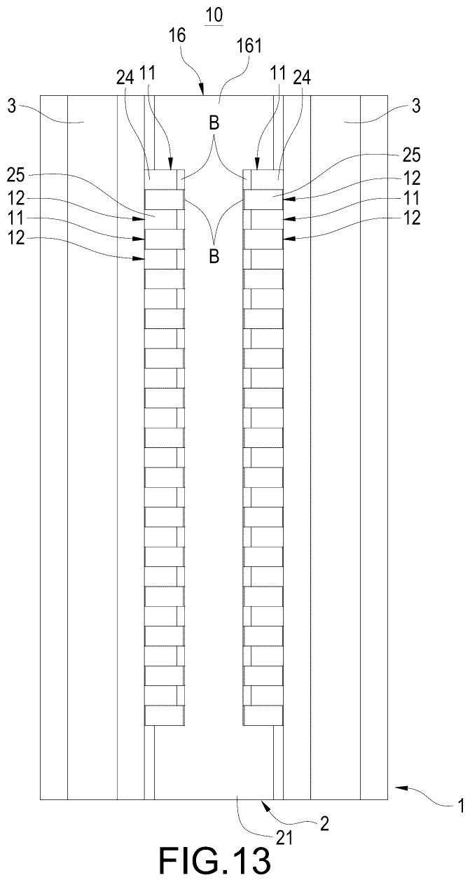

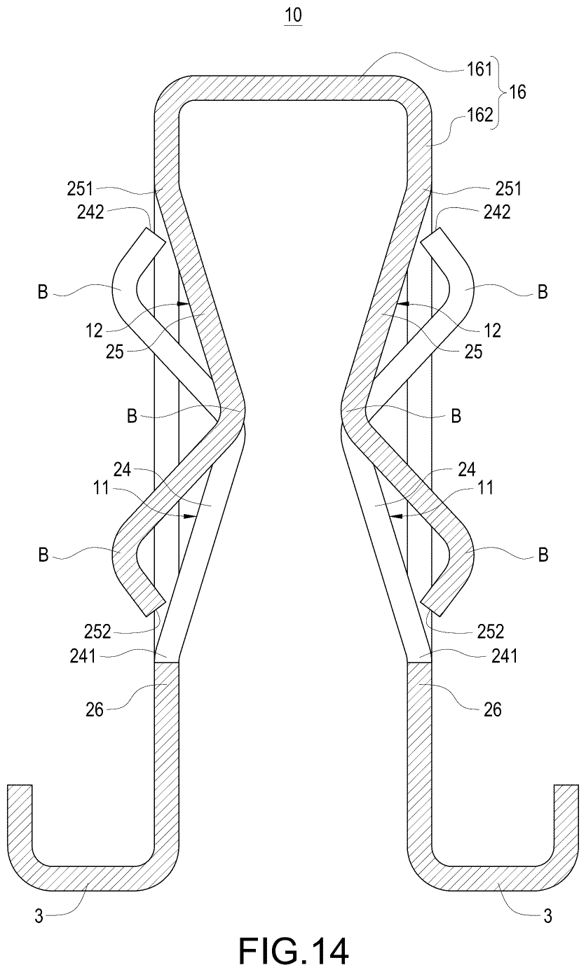

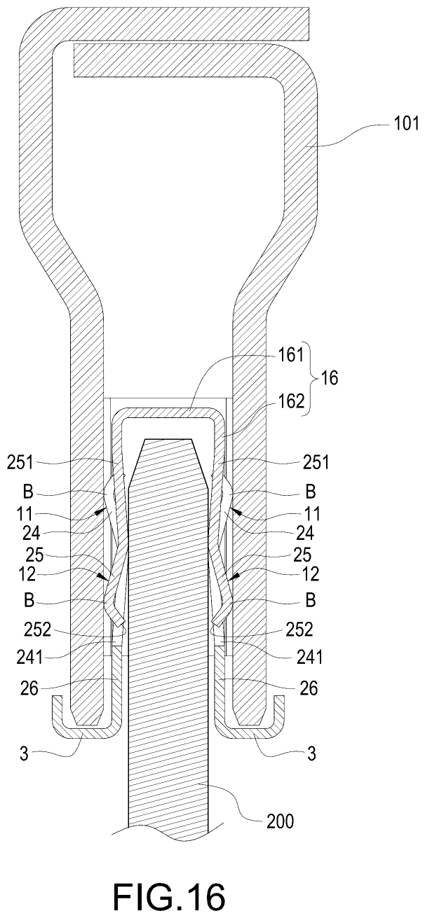

Please refer to FIG. 12 to FIG. 16, showing a third exemplary embodiment of a multi-contact terminal structure 10 and a terminal sheet 2 thereof of the present disclosure. The exemplary embodiment shown in FIG. 12 to FIG. 16 is generally identical to the exemplary embodiment shown in FIG. 1 to FIG. 6. The difference between the exemplary embodiment shown in FIG. 12 to FIG. 16 and the exemplary embodiment shown in FIG. 1 to FIG. 6 mainly relies in the different bending shape of the terminal main body 1.

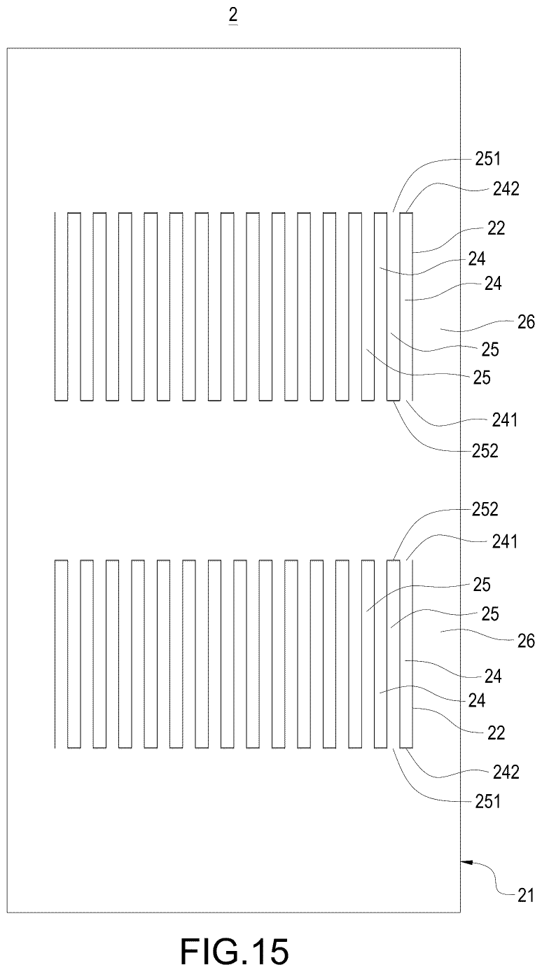

Please refer to further description below. As shown in FIG. 15, in this exemplary embodiment, a quantity of the continuous S-shaped through slot 22 is two; however, the present disclosure is not limited to such quantity only. Subsequently, the conductive metal sheet 21 then undergoes pressing and bending operations. As shown in FIG. 12 to FIG. 14, the terminal main body 1 includes a U-shaped bracket 16 formed by bending the conductive metal sheet 21. The U-shaped bracket 16 includes a horizontal slab 161 and two vertical slabs 162 extended from two opposite sides of the horizontal slab 161. One of the continuous S-shaped through slots 22 is formed at one of the vertical slabs 162, and another one of the continuous S-shaped through slots 22 is formed at another one of the vertical slabs 162. Each of the first terminals 11 and each of the second terminals 12 are formed to extend in opposite directions and arranged alternatively to each other. Each of the first terminals 11 is positioned in each of the second spacings S2 such that it is opposite from each of the second spacing S2, and each of the second terminals 12 is positioned in each of the first spacings S1 such that it is opposite from each of the first spacing S1. Furthermore, each of the first terminals 11 and each of the second terminals 12 include three bending points B formed thereon respectively, such that each of the first terminals 11 and each of the second terminals 12 include protruding points formed to protrude from an outer side of the vertical slab 162 and arranged alternatively to each other. Moreover, the U-shaped bracket 16 includes two L-shaped hooks 3 formed to extend from two ends thereof, such that it may be locked to the two ends of the conducting slab 101 via the two L-shaped hooks 3.

Accordingly, in this exemplary embodiment, as the conductive metal sheet 21 includes the continuous S-shaped through slots 22 formed thereon, they are able to divide and form a plurality of first terminal sections 24 and a plurality of second terminal sections 25 arranged alternatively to each other. As a result, it is not necessary to form excessive cutting slots other than the continuous S-shaped through slots 22 via stamping of the conductive metal sheet 21, to achieve equivalent functions and effects of the exemplary embodiment illustrated in FIG. 1 to FIG. 6.

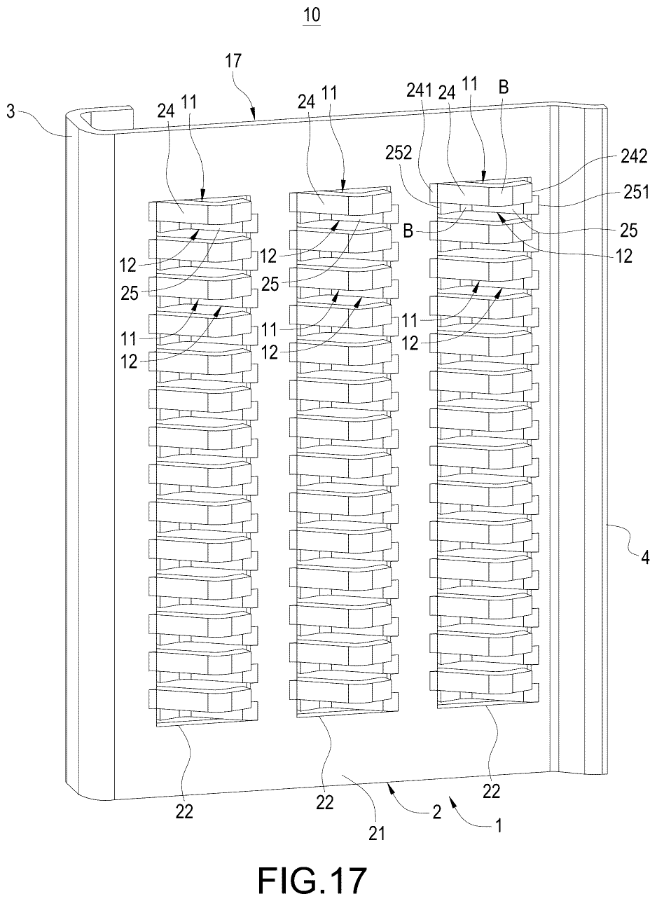

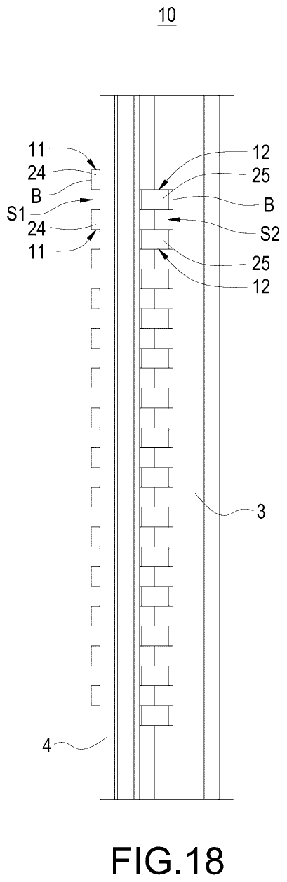

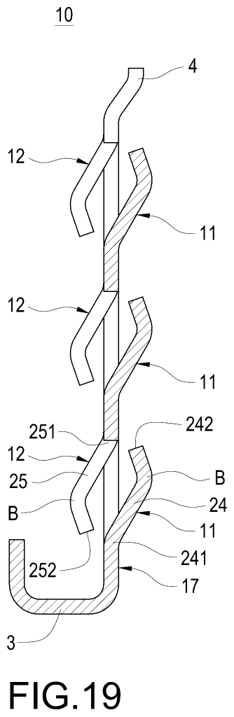

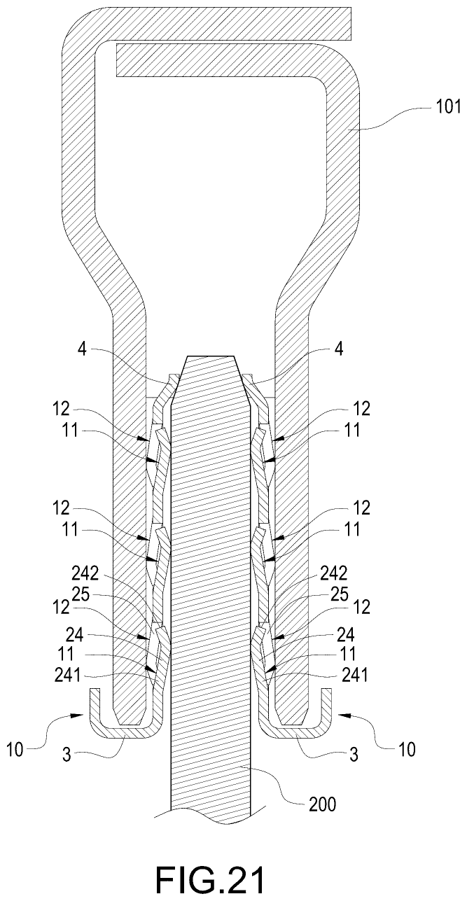

Please refer to FIG. 17 to FIG. 21, showing a fourth exemplary embodiment of a multi-contact terminal structure 10 and a terminal sheet 2 thereof of the present disclosure. The exemplary embodiment shown in FIG. 17 to FIG. 21 is generally identical to the exemplary embodiment shown in FIG. 1 to FIG. 6. The difference between the exemplary embodiment shown in FIG. 17 to FIG. 21 and the exemplary embodiment shown in FIG. 1 to FIG. 6 mainly relies in the different bending shape of the terminal main body 1.

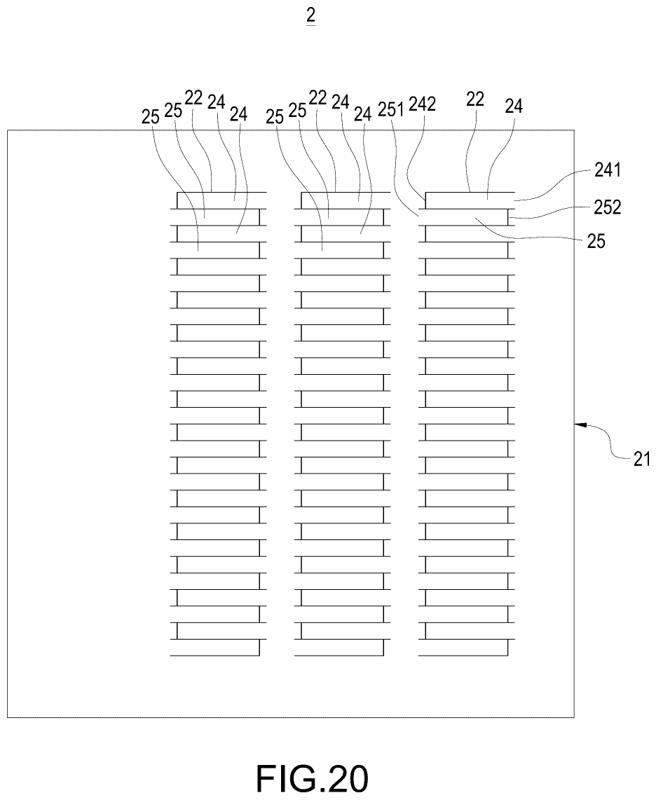

Please refer to further description below. As shown in FIG. 20, in this exemplary embodiment, a quantity of the continuous S-shaped through slot 22 is multiple; however, the present disclosure is not limited to such quantity only. Subsequently, the conductive metal sheet 21 then undergoes pressing and bending operations. As shown in FIG. 17 to FIG. 19, the terminal main body 1 includes a flat sheet area 17 formed without bending the conductive metal sheet 21. The plurality of continuous S-shaped through slots 22 are formed on the flat sheet area 17 and aligned parallel to each other on the flat sheet area 17. Each of the first terminals 11 and each of the second terminals 12 are formed to extend in opposite directions and arranged alternatively to each other. Each of the first terminals 11 is positioned in each of the second spacings S2 such that it is arranged opposite from each of the second spacing S2, and each of the second terminals 12 is positioned in each of the first spacings S1 such that it is arranged opposite from each of the second spacing S2.

Furthermore, each of the first terminals 11 and each of the second terminals 12 include two bending points B formed thereon, such that the plurality of first terminals 11 include a plurality of protruding points formed on one side of the flat sheet area 17 and protruding outward from the flat sheet area 17, and the plurality of second terminals 12 include a plurality of protruding points formed on another side of the flat sheet area 17 and protruding outward from the flat sheet area 17. Moreover, the terminal main body 1 includes an L-shaped hook 3 extended at one end of the flat sheet area 17 and an obliquely folded slab 4 extended at another end thereof, such that it may be locked to one end of the conducting sheet 101 via the L-shaped hook 3, and it may abut against the conducting sheet 101 via the obliquely folded slab 4; however, the obliquely folded slab 4 may be omitted depending upon the actual condition, and the present disclosure is not limited to such configuration only.

Accordingly, in this exemplary embodiment, as the conductive metal sheet 21 includes the continuous S-shaped through slots 22 formed thereon, they are able to divide and form a plurality of first terminal sections 24 and a plurality of second terminal sections 25 arranged alternatively to each other. As a result, it is not necessary to form excessive cutting slots other than the continuous S-shaped through slots 22 via stamping of the conductive metal sheet 21, to achieve equivalent functions and effects of the exemplary embodiment illustrated in FIG. 1 to FIG. 6.

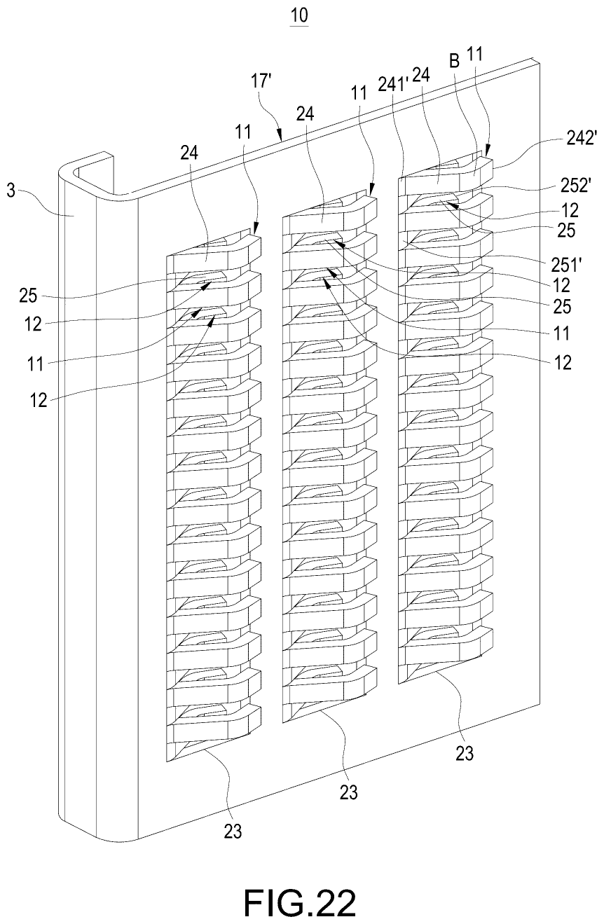

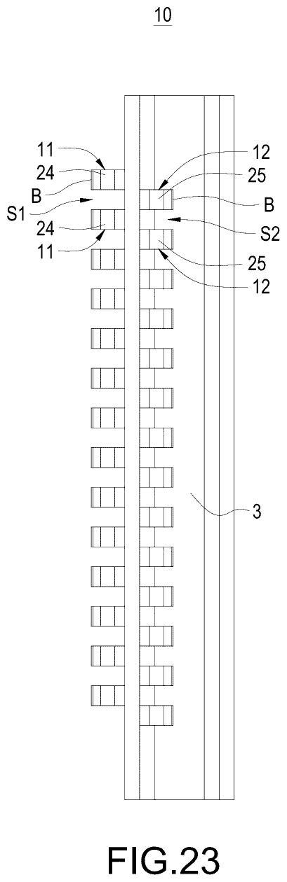

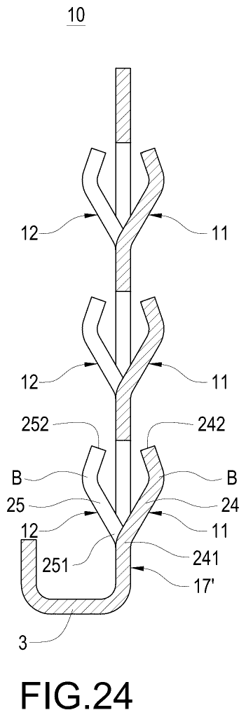

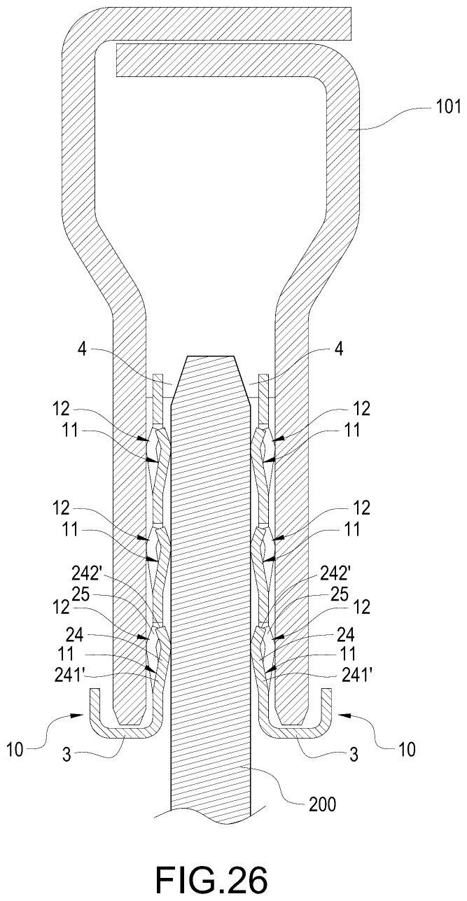

Please refer to FIG. 22 to FIG. 26, showing a fifth exemplary embodiment of a multi-contact terminal structure 10 and a terminal sheet 2 thereof of the present disclosure. The exemplary embodiment shown in FIG. 22 to FIG. 26 is generally identical to the exemplary embodiment shown in FIG. 1 to FIG. 6. The difference between the exemplary embodiment shown in FIG. 22 to FIG. 26 and the exemplary embodiment shown in FIG. 1 to FIG. 6 mainly relies in the different bending shape of the terminal main body 1.

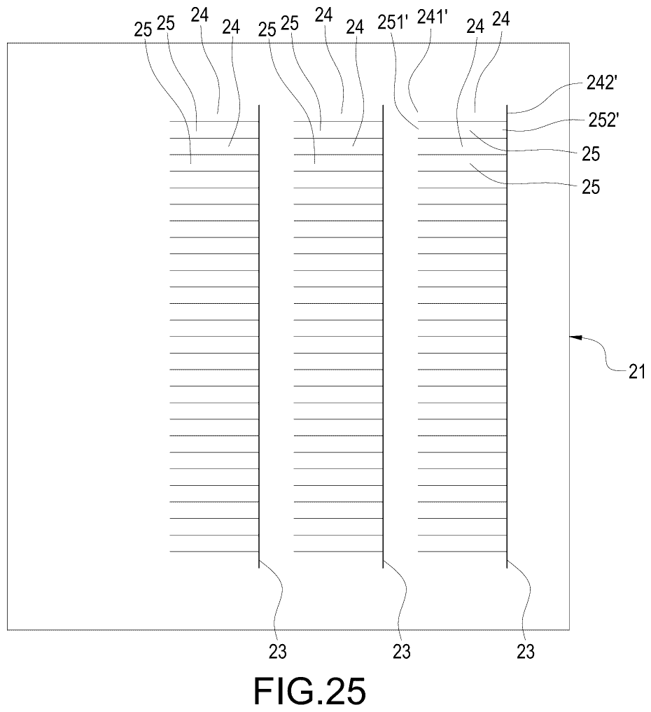

Please refer to further description below. As shown in FIG. 25, in this exemplary embodiment, the conductive metal sheet 21 includes one or a plurality of comb-shaped through slots 23 and a plurality of first terminal sections 24 and a plurality of second terminal sections 25 divided by the comb-shaped through slots 23 and arranged alternatively to each other. The plurality of first terminal sections 24 and the plurality of second terminal sections 25 are divided by the comb-shaped through slots 23. Each of the first terminal sections 24 includes a first connecting end 241′ formed at one end thereof and connected to the conductive metal sheet 21 and a first free end 242′ formed at another end thereof and separated from the conductive metal sheet 21. Each of the second terminal sections 25 includes a second connecting end 251′ formed at one end thereof and connected to the conductive metal sheet 21 and a second free end 252′ formed at another end thereof and separated from the conductive metal sheet 21. Each of the first connecting ends 241′ and each of the second connecting ends 251′ are arranged adjacent and parallel to each other. Each of the first free ends 242′ and each of the second free ends 252′ are arranged adjacent and parallel to each other. In addition, a quantity of the comb-shaped through slots 23 in this exemplary embodiment is multiple; however, the present disclosure is not limited to such quantity only.

Subsequently, the conductive metal sheet 21 then undergoes pressing and bending operations. As shown in FIG. 22 to FIG. 24, the terminal main body 1 includes a flat sheet area 17′ formed without bending the conductive metal sheet 21. The plurality of comb-shaped through slots 23 are formed on the flat sheet area 17′ and aligned parallel to each other on the flat sheet area 17′. Each of the first terminals 11 and each of the second terminals 12 are formed to extend in an identical direction and arranged alternatively to each other. Each of the first terminals 11 is positioned in each of the second spacings S2 such that it is arranged opposite from each of the second spacing S2, and each of the second terminals 12 is positioned in each of the first spacings S1 such that it is arranged opposite from each of the second spacing S2.

Furthermore, each of the first terminals 11 and each of the second terminals 12 include two bending points B formed thereon, such that the plurality of first terminals 11 include a plurality of protruding points formed on one side of the flat sheet area 17′ and protruding outward from the flat sheet area 17′, and the plurality of second terminals 12 include a plurality of protruding points formed on another side of the flat sheet area 17′ and protruding outward from the flat sheet area 17′. Moreover, the terminal main body 1 includes an L-shaped hook 3 extended at one end of the flat sheet area 17′, such that it may be locked to one end of the conducting sheet 101 via the L-shaped hook 3.

Accordingly, in this exemplary embodiment, as the conductive metal sheet 21 includes the comb-shaped through slots 23 formed thereon, they are able to divide and form a plurality of first terminal sections 24 and a plurality of second terminal sections 25 arranged alternatively to each other. As a result, it is not necessary to form excessive cutting slots other than the comb-shaped through slots 23 via stamping of the conductive metal sheet 21, to achieve equivalent functions and effects of the exemplary embodiment illustrated in FIG. 1 to FIG. 6.

In view of the above, the multi-contact terminal structure and terminal sheet thereof of the present disclosure is able to achieve the expected purpose of use and to overcome known drawbacks.

What is claimed is:

1. A multi-contact terminal structure, comprising:
a terminal main body, formed by bending a terminal sheet, the terminal sheet comprising a conductive metal sheet, the conductive metal sheet comprising at least one continuous S-shaped through slot or at least one comb-shaped through slot and a plurality of first terminal sections and a plurality of second terminal sections divided by the at least one continuous S-shaped through slot or the at least one comb-shaped through slot and arranged alternatively to each other, the terminal main body comprising a plurality of first terminals formed by bending the plurality of first terminal sections and a plurality of second terminals formed by bending the plurality of second terminal sections, a plurality of first spacings defined among the plurality of first terminals, a plurality of second spacings defined among the plurality of second terminals, the plurality of first terminals and the plurality of second spacings arranged opposite from each other, and the plurality of second terminals and the plurality of first spacings arranged opposite from each other.

2. The multi-contact terminal structure according to claim 1, wherein the plurality of first terminal sections and the plurality of second terminal sections are divided by the at least one continuous S-shaped through slot, the conductive metal sheet comprises a frame section disposed at a peripheral of the at least one continuous S-shaped through slot, each of the first terminal sections comprises a first connecting end connected to the frame section and a first free end separated from the frame section, each of the second terminal sections comprises a second connecting end connected to the frame section and a second free end separated from the frame section, the first free end and the second connecting end are arranged adjacent and parallel to each other, the second free end and the first connecting end are arranged adjacent and parallel to each other.

3. The multi-contact terminal structure according to claim 2, wherein the terminal main body comprises a W-shaped bracket formed by bending the frame section, the plurality of first terminals are arranged parallel to each other vertically and extended from one of a left side and a right side of the W-shaped bracket, the plurality of second terminals are arranged parallel to each other vertically and extended from another one of the left side and the right side of the W-shaped bracket.

4. The multi-contact terminal structure according to claim 2, wherein the conductive metal sheet comprises two elongated slots extended from two rear ends of the continuous S-shaped through slot and arranged opposite from each other vertically, the conductive metal sheet comprises an extension section disposed between the two elongated slots, each of the first connecting ends and the extension section are integrally formed to be connected to each other, the terminal main body comprises an L-shaped bracket formed by bending the frame section and a vertical protruding slab formed by bending the extension section and arranged at one side of the L-shaped bracket, the plurality of first terminals extends from a rear end of the vertical protruding slab away from the L-shaped bracket, the plurality of second terminals extends from an inner edge of one end of the L-shaped bracket away from the vertical protruding slab and towards an internal of the L-shaped bracket.

5. The multi-contact terminal structure according to claim 4, wherein the L-shaped bracket comprises an L-shaped hook extended from one end thereof away from the vertical protruding slab.

6. The multi-contact terminal structure according to claim 2, wherein a quantity of the continuous S-shaped through slot is two, the terminal main body comprises a U-shaped bracket formed by bending the conductive metal sheet, the U-shaped bracket comprises a horizontal slab and two vertical slabs extended from two sides of the horizontal slab opposite to each other, one of the continuous S-shaped through slots is formed at one of the vertical slabs, and another one of the continuous S-shaped through slots is formed at another one of the vertical slabs, each of the first terminals and each of the second terminals are formed to extend in opposite directions and arranged alternatively to each other, each of the first terminals is positioned in each of the second spacings, and each of the second terminals is positioned in each of the first spacings.

7. The multi-contact terminal structure according to claim 6, wherein the U-shaped bracket comprises two L-shaped hooks extended from two ends thereof.

8. The multi-contact terminal structure according to claim 2, wherein a quantity of the continuous S-shaped through slot is multiple, the terminal main body comprises a flat sheet area formed without bending the conductive metal sheet, the plurality of continuous S-shaped through slots are formed on the flat sheet area and aligned parallel to each other on the flat sheet area, each of the first terminals and each of the second terminals are formed to extend in opposite directions and arranged alternatively to each other, each of the first terminals is positioned in each of the second spacings, and each of the second terminals is positioned in each of the first spacings.

9. The multi-contact terminal structure according to claim 8, wherein the terminal main body comprises an L-shaped hook extended at one end of the flat sheet area.

10. The multi-contact terminal structure according to claim 8, wherein the terminal main body comprises an L-shaped hook extended at one end of the flat sheet area and an obliquely folded slab extended at another end thereof.

11. The multi-contact terminal structure according to claim 1, wherein the plurality of first terminal sections and the plurality of second terminal sections are divided by the at least one comb-shaped through slot, each of the first terminal sections comprises a first connecting end connected to the conductive metal sheet and a first free end separated from the conductive metal sheet, each of the second terminal sections comprises a second connecting end connected to the conductive metal sheet and a second free end separated from the conductive metal sheet, the first connecting end and the second connecting end are arranged adjacent and parallel to each other, the first free end and the second free end are arranged adjacent and parallel to each other.

12. The multi-contact terminal structure according to claim 11, wherein a quantity of the comb-shaped through slot is multiple, the terminal main body comprises a flat sheet area formed without bending the conductive metal sheet, the plurality of comb-shaped through slots are formed on the flat sheet area and aligned parallel to each other on the flat sheet area, each of the first terminals and each of the second terminals are formed to extend in an identical direction and arranged alternatively to each other, each of the first terminals is positioned in each of the second spacings, and each of the second terminals is positioned in each of the first spacings.

13. The multi-contact terminal structure according to claim 12, wherein the terminal main body comprises an L-shaped hook extended at one end of the flat sheet area.

14. The multi-contact terminal structure according to claim 12, wherein the terminal main body comprises an L-shaped hook extended at one end of the flat sheet area and an obliquely folded slab extended at another end thereof.

15. A terminal sheet, comprising:
a conductive metal sheet, comprising at least one continuous S-shaped through slot or at least one comb-shaped through slot and a plurality of first terminal sections and a plurality of second terminal sections divided by the at least one continuous S-shaped through slot or the at least one comb-shaped through slot and arranged alternatively to each other.

16. The terminal sheet according to claim 15, wherein the plurality of first terminal sections and the plurality of second terminal sections are divided by the at least one continuous S-shaped through slot, the conductive metal sheet comprises a frame section formed at a peripheral of the at least one continuous S-shaped through slot, each of the first terminal sections comprises a first connecting end connected to the frame section and a first free end separated from the frame section, each of the second terminal sections comprises a second connecting end connected to the frame section and a second free end separated from the frame section, the first free end and the second connecting end are arranged adjacent and parallel to each other, the second free end and the first connecting end are arranged adjacent and parallel to each other.

17. The terminal sheet according to claim 15, wherein the plurality of first terminal sections and the plurality of second terminal sections are divided by the at least one comb-shaped through slot, each of the first terminal sections comprises a first connecting end connected to the conductive metal sheet and a first free end separated from the conductive metal sheet, each of the second terminal sections comprises a second connecting end connected to the conductive metal sheet and a second free end separated from the conductive metal sheet, the first connecting end and the second connecting end are arranged adjacent and parallel to each other, the first free end and the second free end are arranged adjacent and parallel to each other.
